(19) United States
(12) Patent Application Publication
(10) Pub. No.: US 2023/0009746 A1
(43) Pub. Date: Jan. 12, 2023

(54) Tablet computer protective case with multiple folding ways

(71) Applicant: Jintai LIU, Changsha (CN)

(72) Inventor: Jintai LIU, Changsha (CN)

(21) Appl. No.: 17/371,124

(22) Filed: Jul. 9, 2021

(51) Int. Cl. A45C 11/00; G06F 1/16

(52) U.S. Cl. CPC A45C 11/00; G06F 1/1628; A45C 2011/003; G06F 2200/1633

(57) ABSTRACT

This invention discloses a tablet computer protective case with multiple folding ways including a back casing and a front cover; the front cover is divided into a plurality of connecting sections; each of the sections has a connecting portion which is foldable; a limiting groove is formed at the connecting portion between two sections; a plurality of the sections are each disposed with one or more magnets therein; the back casing is provided with magnets at edges thereof for engaging with the magnets of the front cover. This invention has the following beneficial effects: It can achieve multiple application modes by means of simple geometric folding and alignment of magnets without complicated mechanical structures or components like rotating shafts, thereby significantly reducing product weight and costs.

### BACKGROUND OF THE INVENTION

The present invention relates to the field of tablet computer accessories and more specifically relates to a tablet computer protective case with multiple folding ways.

Currently, the majority of tablet computer protective cases in the marketplace only provide protective function or only support one usage mode; besides, the protective casings currently available in the marketplace has design deficiencies or defects in view of the numerous usage scenarios and modes provided by tablet computer series products.

### BRIEF SUMMARY OF THE INVENTION

It is an object of the present invention to provide a tablet computer protective case with multiple folding ways by means of the following technical solutions:

A tablet computer protective case with multiple folding ways comprising a back casing and a front cover, wherein the front cover is divided into a plurality of connecting sections; each of the sections has a connecting portion which is foldable; a limiting groove is formed at the connecting portion between two sections; a plurality of the sections are each disposed with one or more magnets therein; the back casing is provided with magnets at edges thereof for engaging with the magnets of the front cover.

Furthermore, the front cover comprises a first section, a second section and a third section; the sections are of rectangular shapes of different sizes.

Furthermore, the first section and the second section are connected by a first limiting groove; the second section and the third section are connected by a second limiting groove.

Furthermore, the back casing is provided with a third limiting groove for receiving an edge of the third section.

Furthermore, the first section and the second section each has a foldable triangular section at a bottom portion thereof.

Furthermore, the first section, the second section and the back casing form a triangular prism; the triangular sections on the bottom portions are folded so that the first section, the second section and the back casing form a tilted triangular prism.

The present invention has the following beneficial effects: Three application modes, namely horizontal screen mode, vertical screen mode, and drawing/writing mode, can be achieved by means of simple geometric folding and alignment of magnets. There is no complicated mechanical structures or components like rotating shafts, thereby significantly reducing product weight and costs. In comparison with other products which could achieve multiple tablet computer usage modes by mechanical structures and components, the present invention can largely reduce material wastage rate. The present invention can achieve three different modes of tablet computer usage modes by means of simple geometric segmentation and magnetic attraction.

### BRIEF DESCRIPTION OF THE DRAWINGS

FIG. 1 is a schematic view of the protective case of an embodiment of the present invention.

FIG. 2 is a schematic view of the first mode of the embodiment of the present invention.

FIG. 3 is a schematic view of FIG. 2 in another perspective.

FIG. 4 is a schematic view of the second mode of the embodiment of the present invention.

FIG. 5 is a schematic view of FIG. 4 in another perspective.

FIG. 6 is a schematic view of the third mode of the embodiment of the present invention.

FIG. 7 is a schematic view of FIG. 6 in another perspective.

FIG. 8 is another schematic view of the protective case of the embodiment of the present invention.

### DETAILED DESCRIPTION OF THE INVENTION

The present invention is clearly and comprehensively explained herein with reference to the accompanying drawings in the embodiment of the present invention. Obviously, the embodiment that is described herein is only one of the possible embodiments of the present invention but not the only embodiment of the present invention. All other embodiments obtainable without any inventive effort by a person skilled in this field of art based on the embodiments of the present invention disclosed herein should also fall within the scope of protection of the present invention.

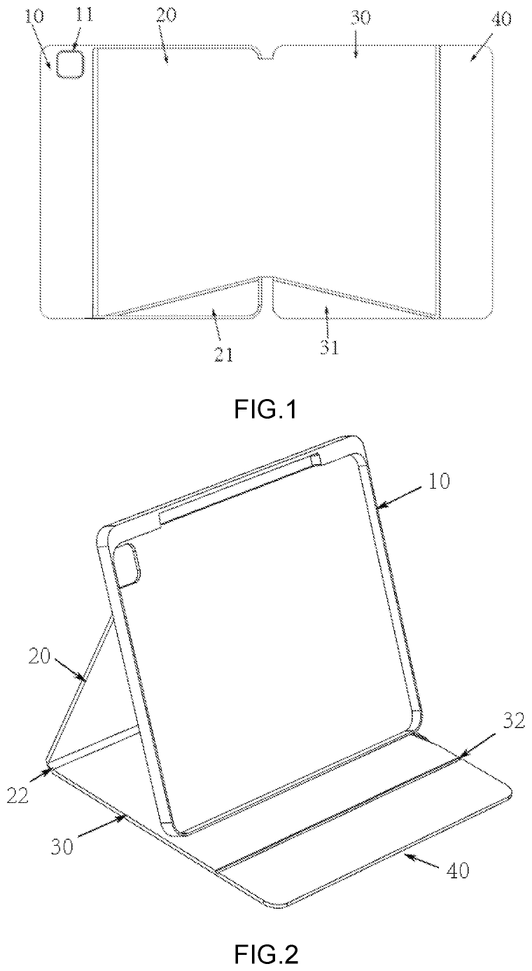

As shown in FIGS. 1 and 8, in the embodiment of the present invention, the tablet computer protective case with multiple folding ways comprises a back casing 10 and a front cover 20, 30, 40. The front cover is divided into three connecting sections; each of the sections has a connecting portion which is foldable. A limited groove 22, 32 is formed at the connecting portion between two sections. The back casing 10 and the sections 20, 30, 40 are each disposed with one or more magnets 16, 26, 36, 46 therein so that the magnets are not exposed. Each of the sections is covered by PU leather and various patterns and colors could be printed on the PU leather to increase fun and aesthetic appeal. The back casing 10 is provided with magnets 16 at edges thereof for engaging with the magnets of the front cover so that the magnets as well as the front cover and back casing can attract each other when folding.

Each of the sections has a surface material formed by PU leather, authentic leather or other materials, and is covered with a layer of hard material such as plastics, metal sheet with magnetic properties and so forth.

A camera hole 11 is provided on the back casing 10, the size and position of which are determined according to model number of the tablet computer.

The front cover comprises a first section 20, a second section 30 and a third section 40; the sections are of rectangular shapes of different sizes.

The first section 20 and the second section 30 are connected by a first limiting groove 22; the second section 30 and the third section 40 are connected by a second limiting groove 32; the back casing 10 is provided with a third limiting groove 12 for receiving an edge of the third section 40.

The first section 20 and the second section 30 each has a foldable triangular section 21, 31 at a bottom portion thereof.

The application is described as follows:

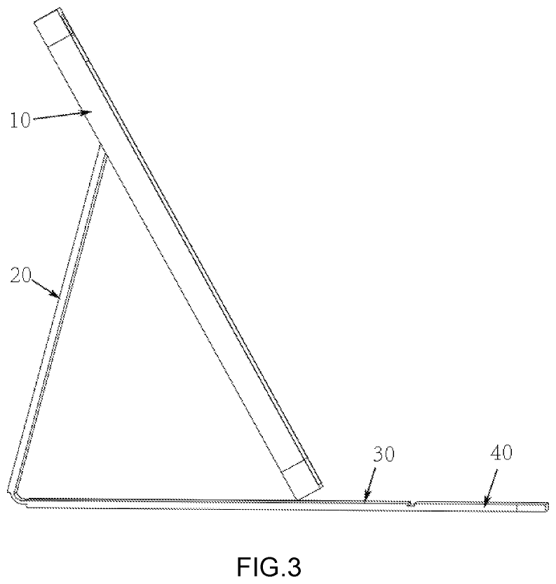

FIGS. 2-3 show a horizontal screen mode: After opening the front cover on the front side, the front cover forms a certain angle with the back casing; by means of the frictional force between the anti-skidding PU material of the front cover and the back casing, the back casing can be stably supported on the front cover at any angle.

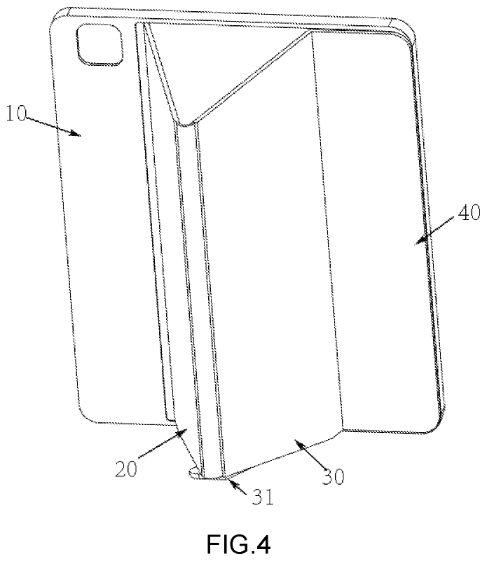

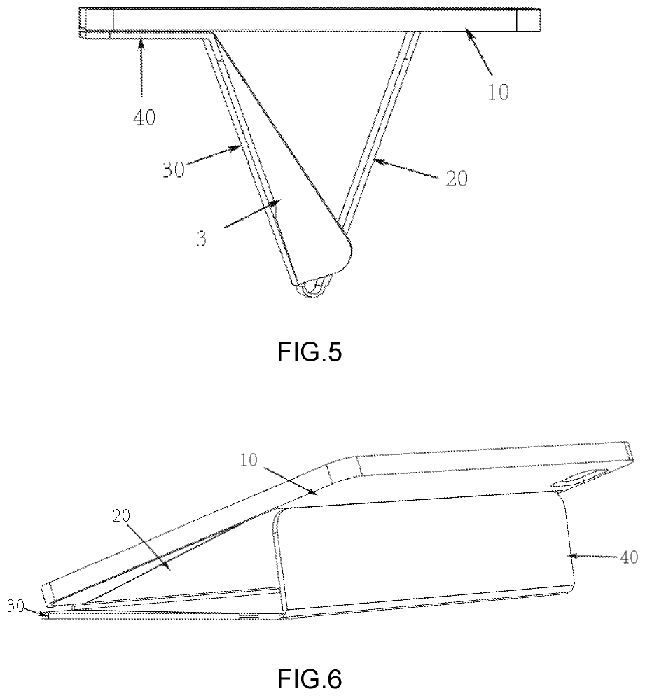

FIGS. 4-5 show a vertical screen mode: At the vertical state, after opening the front cover on the front side, the front cover forms a certain angle with the back casing; the third section of the front cover is attracted to the back casing by means of the magnets to form a stable triangular prism; when the triangular sections are folded at a certain angle, the protective case as a whole can be tilted backwards for a certain degree, so that the tablet computer could remain stable at vertical mode. This also suits ergonomics and can alleviate fatigue and discomfort at the neck when users use the tablet computer at vertical mode.

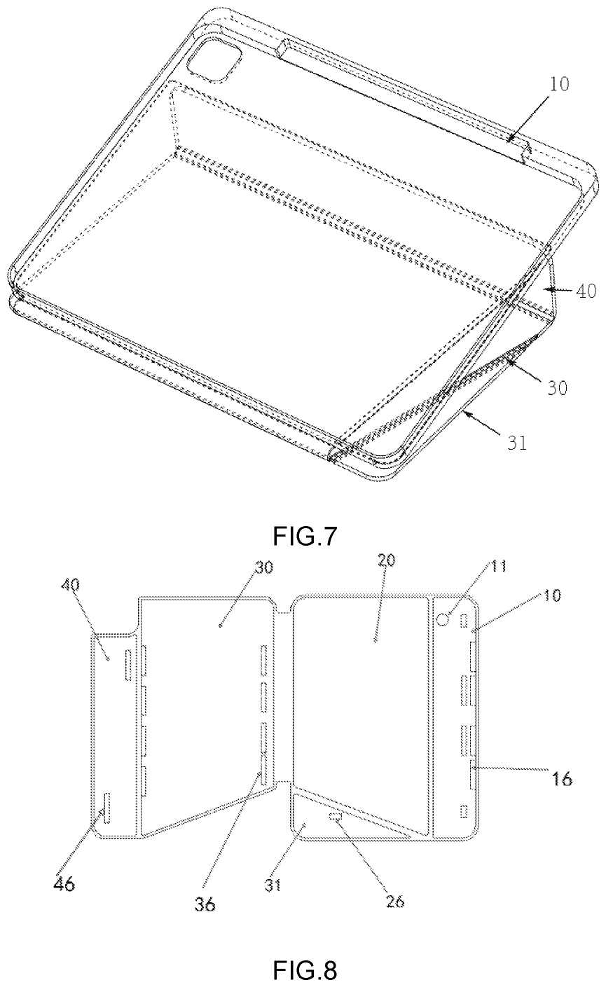

FIGS. 6-7 show a drawing/writing mode: The front cover is completely folded backwards, the third section is folded upwards for a certain angle so that its edge is received in the third limiting groove provided at the back casing and fixed by means of the magnets. The second section of the front cover is placed on the desk horizontally, so that the tablet computer is raised to an angle which is suitable for drawing and writing.

The present invention has the following beneficial effects: All three modes can be achieved by means of simple geometric folding, thereby fulfilling ergonomic optimization. In horizontal screen mode, stepless adjustment at any angle is possible, thereby suitable for use at various scenarios. The fixed vertical screen mode can prevent users from gripping the tablet computer for prolonged period to keep it stable, thereby alleviating burden of neck and hand. The slightly raised drawing/writing mode is suitable for users who frequently use tablet computers for drawing and writing. The slightly raised angle allows user's pen-gripping hand to naturally fall on the tablet computer to draw or write, thus avoiding operation on completely flat surface, thereby alleviating burden of neck and hand.

While the embodiment of the present invention has been described and illustrated to the fullest extent, the persons skilled in the art may make any changes, modifications, alternations and variations without departing from the principle and spirit of the present invention. The scope of the present invention is defined by the accompanying claims and equivalents thereof.

What is claimed is:

1. A tablet computer protective case with multiple folding ways comprising a back casing and a front cover, wherein the front cover is divided into a plurality of connecting sections; each of the sections has a connecting portion which is foldable; a limiting groove is formed at the connecting portion between two sections; a plurality of the sections are each disposed with one or more magnets therein; the back casing is provided with magnets at edges thereof for engaging with the magnets of the front cover.

2. The tablet computer protective case with multiple folding ways as in claim 1, wherein the front cover comprises a first section, a second section and a third section; the sections are of rectangular shapes of different sizes.

3. The tablet computer protective case with multiple folding ways as in claim 2, wherein the first section and the second section are connected by a first limiting groove; the second section and the third section are connected by a second limiting groove.

4. The tablet computer protective case with multiple folding ways as in claim 2, wherein the back casing is provided with a third limiting groove for receiving an edge of the third section.

5. The tablet computer protective case with multiple folding ways as in claim 2, wherein the first section and the second section each has a foldable triangular section at a bottom portion thereof.

6. The tablet computer protective case with multiple folding ways as in claim 5, wherein the first section, the second section and the back casing form a triangular prism; the triangular sections on the bottom portions are folded so that the first section, the second section and the back casing form a tilted triangular prism.
